(19) United States
(12) Patent Application Publication
(10) Pub. No.: US 2015/0096391 A1
(43) Pub. Date: Apr. 9, 2015

(54) Lifting Gear and Its Matched Retractable Container

(71) Applicant: JianWei LIU, (US)

(72) Inventor: Jianwei Liu, London (GB)

(21) Appl. No.: 14/402,758

(22) PCT Filed: May 24, 2013
(86) PCT No.: PCT/CN13/76191

§ 371 Date: Nov. 21, 2014

(30) Foreign Application Priority Data
May 24, 2012 (CN) 201210165177.8

(51) Int. Cl. B65F 1/14; F16H 19/00

(52) U.S. Cl. CPC B65F 1/1452; F16H 19/003; B65F 1/1473
USPC 74/89.22

(57) ABSTRACT

The lifting gear consists of 3 systems (FIG. 1):
1. 1^{st} Axle System: 1^{st}-axle, 1^{st}-balancer, base board, on the 1^{st}-axle there is a direction-controlling ratchet wheel and a set of (totally 6) 1^{st}-fixed-pulleys.
2. 2^{nd} Axle System: a 2^{nd}-axle, a 2^{nd}-balancer, a clutch within and a 2^{nd} stepping gear of 2^{nd}-balancer-lifting. On the 2^{nd}-axle, a pair of 2^{nd}-fixed-pulleys, 2^{nd}-chains/ropes with the 2^{nd}-balancer on one end and a plummet on the other end. The 2^{nd} stepping gear for pulling the 2^{nd}-balancer, includes a driven wheel attached to a 2^{nd}-axle, a small driving wheel, a large driving wheel, a 1^{st}-gliding bar, pressure lever and a 2^{nd} direction-controlling ratchet wheel.
3. 1^{st} Applying System of Auxiliary Lifting for lifting the base board: a fly wheel on 1^{st}-axle, a 1^{st}-gliding-bar, a pressing-surface (pedal).

The retractable container is for a special usage of the device, namely, the retractable wheelie bin (FIG. 12).

### TECHNOLOGY CATEGORY

The invention is related to a lifting gear and a specially designed container (retractable wheelie-bin).

### BACKGROUND

Due to urban development in recent decades, there is less and less useable space in city living, which leads to a crowded living space in home life and in most inner city streets. In the other hand, owing to improving efficiency and consciousness of protecting environment, wheelie bins are used universally, that worsens visual pollution because of one or a few huge dustbins squeezed in a small front yard for each household. At present, there are some technologies which try to solve this problem, but none of them can provide a practical, economical, and useable design suitable for domestic usage.

The Chinese patent 200620097663.0 reveals a sinkable hydraulic dustbin. It consists of dustbin case, scissor linkage mechanism, hydraulic system, electrical controlling system and underground pit. At the front of the side case, there are front door shutter bold and opening lever, at the back there is a pushing board with a hydraulic pump, a photosensor is near the rubbish entrance on top and it is connected with PLC of the electronic control system. One end of the scissor linkage mechanism is fixed on one side of the underground pit, the other end glides along a groove; a hydraulic pump is fixed within the scissor linkage mechanism on the bottom of the pit. One end on the top of the scissor linkage mechanism is fixed on the side of the dustbin case and the other end also glides along a groove.

Chinese Patent 200410046941.5 reveals a balancing underground rubbish storage station which consists of dustbin case, hydraulic pumps, pulling cables, a set of pulleys and balancers. The hydraulic pumps are installed under the dustbin case; one end of the pulling cables is connected with the dustbin case, the other with balancers, it bypasses a set of pulleys, which are fixed on the ground.

Chinese Patent 02274879.2 reveals a sinkable dustbin, which has a top hung door on the top of the case for throwing in rubbish; there is a bottomless drawer within the outer rubbish case, a pushing board at the back inside the case, with a scissors linkage mechanism operated by a hydraulic pump for compressing or pushing out rubbish. The dustbin is sunk inside the ground with a hydraulic pump lifting system underneath to control its up and down.

Chinese Patent 200920008428.5 reveals a sinkable dustbin with pedal operating lid. Its lid is hinged to the top part of the outer case; there is a linkage bar within the outer and inner dustbin case, one end of which connects to the lid and the other to a pedal in the front. The lid will open when pressing the pedal.

Most of the above patents are for disguising dustbins in public places, so they are often combined with a hydraulic, electrical power, using power in the garbage truck or even use man-power to lift the bin up; some of them are only focus on the mechanism of the lid-opening, the others leave a large part of the devices above ground, therefore, they are not space-saving, convenient, practical and universally adaptable solutions.

### CONTENT OF INVENTION

To overcome this, through applying principles of Ergonomics, such as, lifting 30 kg weight is hard, but it is very easy to produce 20-30 kg downwards force by using both hand and a bit of your own body weight, and 8-10 kg if using one hand; one can even produce a couple of dozen kilogram downward force or even you own body weight by using your foot, etc., and combining this with the principle of balancer, a mechanism is ingeniously designed. The device can use a series incoherent and light action to accumulate energy to raise the loads when it is needed, and provide a whole set of solutions for underground storage, and achieve the goal of lifting loading without electrical or hydraulic power sources. When using the device for disguising dustbins, it gives a special design, namely, a retractable dustbin. This retractable dustbin idea comes from the fact that rubbish is usually accumulated daily; the extendable dustbin body can be adjusted according to the capacity need, and the dustbin can be partly or wholly buried underground, thus achieve the purpose of transfiguring the city environment but also reducing dig-depth of the device.

Furthermore, the device can be used for creating storage space, fulfill the needs of storing sundries, DIY or gardening tool, setting up a receiving box for internet shopping, etc. For this reason, we call the dustbin on the base board as loading, contents etc. in this description, in order that the design can be used for varied household storage purposes.

To achieve the above goal, this device provides a lifting gear, which includes:
A 1^{st}-axle with a 1^{st}-direction-controlling ratchet wheel switch and a set of 1^{st}-fixed-pulleys, a 1^{st}-balancer on one end of a set of 1^{st}-chains, and a base board, which moves in reverse direction with the 1^{st}-balancer on the other end of the 1^{st}-chains.

To implement the idea, it also includes:
A 2^{nd}-axle with a pair of 2^{nd}-fixed-pulleys turning synchronously; 2^{nd}-balancer hanged under the 1^{st}-balancer by a pair of 2^{nd}-chains through holes on the 1^{st}-balancer. In the 2^{nd}-balancer, there is a clutch which can cling onto or release from the 1^{st}-balancer when it touches the bottom of the 1^{st}-balancer. A 2^{nd}-stepping gear for pulling up the 2^{nd}-balancer, which goes up a certain distance each time, consists of a driven wheel attached to the 2^{nd}-axle, engaging with a small driving wheel, a large driving wheel on the same axle as the small driving wheel, a 2^{nd}-gliding-bar, a pressure lever and a 2^{nd} direction-controlling ratchet wheel on the axle of the driving wheels.
Within this described structure, the set of 1^{st}-fixed-pulleys are a pair of toothed wheels and another set of 4 toothed or rope wheels working synchronically, in order to keep the base board level. The pair of 2^{nd}-fixed-pulleys can also be toothed or rope wheels.
Within the structure, the clutch in the 2^{nd}-balancer is in an inactive mode when it is on the bottom of the device, but is in an active mode when it is off the bottom. When the 2^{nd}-balancer ascends until it touches the bottom of the 1^{st-}balancer, the clutch clamps and clings on to the 1^{st-}balancer; there is a groove or a lug on the bottom of the 1^{st} balancer which is for the clutch to clamp on; the clamping device is a spring device.
In this embodiment, it also includes a 1^{st} apply gear for assisting in hoisting the base board, it consists of a pressing surface, a 1st-gliding-bar underneath and a fly wheel, which is a one-way turning ratchet fixed on the 1^{st-}axle.
Within this structure there is also a housing, which consists of an outer and an inner case, buried in the ground.
On the other hand, the design provides a container used within the lifting device.
Furthermore, this container can be a wheelie bin.
More specifically, this wheelie bin is a standard wheelie bin for standard garbage trucks.
And, it can be a retractable wheelie bin, with a standard wheelie bin height when it is stretched and half height when retracted.

The device is classified into 3 standalone but also associated systems which can be used on its own or combined optionally, detailed as below:

1^{st} Balancer System:

(Please refer to FIG. 1. As it is an isometric drawing, there are some places which are not clear due to overlapping, please refer plan, and section drawings in FIG. 2-4.)

By using the principle that a normal person can easily press out 20-30 kg downward force with both hands, this system provides a mechanism to accumulate energy for pulling up loading. Due to the fact that the system is connected direct to the baseboard, it is the main skeleton of the whole design (so when we use other system(s) mentioned below without this system, the basic structure still needs to be retained for passing on actions to lift up baseboard.)

It contains 1^{st}-axle (3), 1^{st}-balancer (1), baseboard (5); on 1^{st}-axle, a 1^{st} direction-controlling ratchet wheel switch is attached, as well as a set of 1^{st}-fixed-pulleys (2a-2f); 1^{st}-balancer is on one side of 1^{st}-chains (4) and/or ropes of a set of 1^{st}-fixed-pulleys, and baseboard is on the other side and move in reverse direction of the former.

The 1^{st-}balancer which is a certain shaped weight preferably use high density material such as iron or lead etc. with a cuboid shape in order to reduce the volume of the device; the function of it is to cancel out part or all of the loading weight. In other words, the 1^{st} balancer's descending causes the baseboard's ascending. When deciding the weight of the balancer, a 20-30 kg weight of a normal person's easy downward force should be considered, but 50-70 kg of a normal person weight can also be considered for some special applications. Another factor to be considered is whether there is an original weight on the loading side in its application, for example, for an application device of storing 30 kg tools or sundries, 30+20(downward force)=50 kg of a balancer can be used; but for sinkable dustbin application device, a 50 kg balancer will make pushing down a light, empty bin underground a bit over the comfort zone. Please refer to more examples in the Example Applications section.

In this system, there are 2 combinations of the 1^{st}-fixed-pulley sets: 1. a pair of toothed wheels (2a, 2b) with another set of toothed wheels (2c, 2d, 2e, 2f); 2. a pair of toothed wheels (2a, 2b) with a set of rope wheels (2c,2d,2e,2f). Both combinations are pulling the 4 corners of the baseboard, keeping them level. In the actual application, a cheaper option of using rope wheels can be used, but there should be at least a pair of toothed wheels being applied symmetrically in order to keep the baseboard level and eliminate offset when going up or down.

Depending on the different applications, the baseboard can be separated with the container above or can be combined the bottom of the container with the baseboard and chains/ropes can be fixed to the bottom of the container (refer to the Example Application 2).

In this system, the 1^{st} direction-controlling ratchet (called 1^{st}-switch below), which is a controllable 2 direction ratchet wheel, is used to set the 1^{st-}Axle's allowing turning direction, which can be achieved with other existing technology. FIG. 11 is one of the designs, its controlling button (which is formed by hard plastic in the core, moulded with soft rubber around it) is placed on top of the pedal of the 1^{st} applying gear of auxiliary lifting system; it pushes the toggle bar (27) in a place where it sets the turning in only one direction (shown by the arrow in the figure), therefore the ascending or descending state can be achieved by pressing buttons.

2^{nd} Balancer System:

Another system of the device, it includes: a 2^{nd}-Axle (14), a pair of 2^{nd}-fixed-pulleys (12); a 2^{nd}-balancer (10) which is hung under the 1^{st}-balancer by a pair of 2^{nd}-chains (11) through holes (24) in the 1^{st}-balancer (a pair of plummets are on the other end of the 2^{nd}-chains), it also includes a clutch device (21) which can clamp onto the 1^{st}-balancer when it touches its bottom. Furthermore, it has a 2^{nd} stepping gear for pulling up the 2^{nd}-balancer, which includes: a 2^{nd}-press-lever (20) (or surface) connected with the top lid, a gliding bar underneath, a large driving wheel (17), a small driving wheel (16) on the same driving axle (25), a driven wheel (15) on the 2^{nd} axle and a direction-controlling ratchet (18) (called 2^{nd}-switch below, is the same type as the 1^{st}-switch) on the driving axle (25). Other methods of lifting the 2^{nd}-balancer can be used.

This system is an auxiliary to complement the 1^{st} balancer system. Through the lever principle, the 2^{nd}-balancer's lifting is designed to use one-hand operation to accumulate energy of position by unaware daily operating. When the 2^{nd}-balancer ascends and touches the bottom of the 1^{st}-balancer, its clutch clamps and hangs on to the 1^{st}-balancer, thus the total weight is used to lift the loading on the baseboard through the 1^{st} balancer system. Its material and shape selection follows the same requirement of the 1^{st}-balancer. Part of the reduced torque is obtained through the ratio of the diameters of the large and small driving wheels, the other is gained through the arm lengths ratio of the pressing point and the gliding bar position on the 2^{nd}-press-lever (refer to FIG. 5D). According to the principle of lever, the reduced ratio of the operating force to the 2^{nd}-balancer is in the reverse ratio of raising distance of the 2^{nd} balancer, that is to say, the more operating force reduced, the less distance the 2^{nd}-balancer raised up, and more times of operating is needed. Because the weight of 2^{nd}-balancer is set according to the potential weight of load, so the ratio of the large and small driving wheel diameters, ratio of the arm length of the force points, total lifting height and designated pressing times need to be calculated accordingly.

The 2^{nd}-switch is the same as the 1^{st}-switch, for example, is a 2-way controlling ratchet (refer to FIG. 6), is used to set the allowing turning direction of 2^{nd}-axle. For example, when the 2^{nd} balancer is going up, the 2^{nd}-axle is only allowed turning in counter clockwise (view from right to left); and vice versa.

The reason placing the 2^{nd} switch on the driving wheel axle but not the 2^{nd-}axle is, that the turning direction of the driving wheels is opposite to the 2^{nd}-axle, therefore the toggle direction of the 2^{nd}-switch to control a related turning direction is matched the controlling direction of separating gliding bar and large driving wheel, and it is easier to impose a device controlling both action at the same time. Refer to FIGS. 5A and 5B (be aware that due to the 2^{nd}-switch is behind the large driving wheel, in order to illustrate clearly, figure A-C is a view from left to right, therefore wheel turning directions shown are different). When the large driving wheel is working, it is toothed with the 2^{nd}-gliding-bar, so when the gliding bar goes up or down, the large driving wheel will turn in both directions. However, because the large driving wheel is a one-direction ratchet wheel, it will slip around the driving axle when gliding bar goes up, but when gliding bar goes down, it drives the large driving wheel turning in counter clockwise (view from left to right; and the 2^{nd}-switch must be toggled to the position to let the driving axle turn in counter clockwise at this moment), the small driving wheel will be force to turn in the same direction around the driving axle (25), and then the small driving wheel will drive the driven wheel (15) and its axle (14) to turn in clockwise thus life up the 2^{nd} balancer to a certain height. When the 2^{nd} and the 1^{st} balancers comes together and the gliding bar cannot be pressed down, the gliding bar needs to be separated from the large driving wheel by pushing the gliding bar to the back, the linkage sleeve (28) pulls the 2^{nd}-switch's toggle bar and set it to allow the driving axle turning only in clockwise, this would eliminate the need to toggle the switch later when the loading needs to be lifted up. FIG. 5C is showing the tip of 2^{nd}-gliding-bar detailed design in which it can sit on opening lip on the top of the device, and the action to push it in the sitting slot of 2^{nd}-gliding-bar (31) will also make sure pulling the toggle bar to the correct position of the 2^{nd}-switch by the linkage sleeve (28), simplify the operation when opening the top lid to raise the loading.

In this system, the function of the clutch in the 2^{nd}-balancer is to connect 2 balancers when they ascend and touch each other, and the 2^{nd}-balancer's weight will be added on to the 1^{st}-balancer in order to raise heavier loadings. There is a groove or lug(s) (26) on the bottom of the 1^{st}-balancer for the clutch to clamp on. The requirement for designing the clutch is firstly, to set it in an inactive mode when the 2^{nd}-balancer is on the bottom of the device, therefore when operate the 1^{st}-balancer System to store up some energy by pushing down the baseboard, only the 1^{st} balancer is lifted up. Secondly, when it leaves the bottom, it is in an Active Mode, so when 2^{nd}-balancer ascends and touches the bottom of the 1^{st}-balance, the clutch then clamps on to the groove or lug(s). There are varied methods to achieve this requirement. FIG. 7 (1-4) is the illustration of the working states of the clutch; FIG. 8-9 are 2 designs of the clutch, they are all use balancer's own weight to push a scissor-shaped clamper or spring bolts in a separated position with the 1^{st}-balancer's groove or lugs, and are in working state when leaving the bottom position under the effect of springs inside.

1^{st} Applying System of Auxiliary Lifting:

Refer to FIG. 10-11.

It is the 3^{rd} system of this device. When the 1^{st} and 2^{nd} balancers total weight cannot lift up the loadings, this system can be applied to assist its lifting by providing extra force through the foot-pedal; other situations that this system need to be used are that when the 2^{nd}-balancer system is out of order or the 1^{st}-balancer's weight cannot outdo the loading, or when this system is chosen as the only lifting method due to the cost consideration.

This system includes a pressure surface (6, the pedal), a 1^{st}-gliding-bar (7) underneath and a 1^{st}-driven-ratchet-wheel (8, fly wheel). The fly wheel (8) is connect with the 1^{st}-axle (3). This 1^{st}-force drives the fly wheel (8) to turn the 1^{st}-axle and lifts up the baseboard. Before the pedal is pulled up for its operation, the gliding bar is in a separated position with the fly wheel, therefore, it will not obstruct the operation of the base board's ascending or descending; when pressing button (refer to FIG. 10. Component 35, its core is hard plastic with elastic soft rubber surrounding) at the front edge of the pedal, to let the fixing bolt (36, spring 39 fixed within) release the pedal (6). While lifting the front of the pedal, the spring (38) underneath pulls the pedal forward, the back edge (33) of the pedal slips into the turning groove (34), and the gliding bar snaps in with the fly wheel (8) (37 is a stopping bar). In the same principle as the 2^{nd} Stepping Gear in the 2^{nd} balancer system, when gliding bar goes up, the driven ratchet wheel slips around the 1^{st}-axle (3); when the gliding bar is pressed down, it drives the 1^{st}-axle turning in counter clockwise (view from right to left), thus turns the 1^{st}-fixed-pulleys in the same direction and pull up the loadings. Be aware that the operating condition of this 1^{st} Applying System of Auxiliary Lifting is, the 1^{st}-switch (9) (which is a 2-way controllable ratchet) is set in the position of allowing the 1^{st}-axle turning in counter clockwise, but not clockwise. To be more specific, before using the pedal, ‘ascending’ button needs to be pressed (refer to FIG. 11) to let the loadings on baseboard be pulled up step by step by each footwork without slipping backwards.

The three systems of this device is a complete and convenient solution when adopted fully; it can also be applied with any combinations or even a single system according to an actual application or budget.

When using a combination or a single one without the 1^{st} Balancer System, a necessary adjustment is needed. For example, using only 2^{nd} balancer system, that basic structure, namely, the clutch device (the groove or lugs feature), 1^{st}-axle and its fixed pulleys and its 1^{st}-switch needs to be retained in order the 2^{nd} balancer system to connect and operate. Using only 1^{st} Applying System of Auxiliary Lifting, the 1^{st} axle and its 1^{st}-switch as well as chain and pulley structure needs to be in place for the driving mechanism to connect and take effect. To be more accurate, not using 1^{st} balancer system is actually just taking off the 1^{st} balancer itself. And using or not using a system will make the device have different features. For example, when not using the 1^{st} balancing system, the content on base board will be able to sink to the device bottom without pressing it down; when using only the 2^{nd} balancer system, you can adopt a very heavy balancer theoretically, and use the 2^{nd}-lever to pull up the balancer with repeating actions; using only the 1^{st} applying gear of auxiliary lifting is also able to lift up heavy loadings with a matching level mechanism; and using only the 1^{st} balancer system, giving a balancer of a weight, of which the positive/negative differentials with the loading weight is less than the maximum pulling/pressing force of a normal person, will make the system useable, i.e., with the help of the 1^{st}-balancer, using the maximum lifting/pressing force to operate the system, a person can pull up or push down the loading. Combining the systems would combine their features, please refer to the Application Example 1 for explanation of varied system(s) and combinations.

The device is placed within a double layer case (considering the requirement of anticorrosion and cost, plastic is preferred), namely, the outer case (contacted with earth) and the inner case which is for the container or contents of the base board moving within, and the double layer walls of the case also support the parts of the device. The container or content on the base board can be designated for different type of usage, such as a cupboard or shelves for storing sundries and tools, a container for carrying solid/liquid or a dustbin.

The Important Application (the Original Inspiration of the Invention)—Retractable Wheelie Bin:

This retractable wheelie bin consists of 2 similar height sections, the upper barrel (40) is wider, the lower barrel (41) is narrower. FIG. 12 shows front, back, side and retracted front views of the retractable wheelie bin. When it is extended, it is a standard height wheelie bin for standard dustbin truck to handle; comparing to usual standard wheelie bin, the distance of the 2 wheels (45) on the base is shorter, making it goes into the lower barrel body, in order that they would not obstruct the upper barrel coming down when it is retracted. When the bin is needed to extend, hold two sides of the bin and lift up lightly, the rubber ring (47) on the lower barrel edge will be squeezed and hold the upper barrel edge (refer to FIG. 15), then pull the small pivoted lever (44) positioned diagonally near the touching edges of 2 barrels to secure it (FIG. 14); when retracting it, process the above steps in a reverse order.

The idea of the retracting device comes from the fact that the quantity of rubbish accumulated is increased day by day, its usage can match the adjustable volume, and can be hidden partly or wholly underground in order to transfigure the street view with less digging depth of the device. More specifically, after each dustbin collection, a user retracts the bin, press down into an underground device with half of the normal dustbin height. Afterwards, by lifting and closing the top-lid of device (there is a connecting bolt (46) to hold the wheelie bin lid which makes them open at the same time, refer FIG. 16) for throwing rubbish in everyday, the device accumulates 2^{nd}-balancer's energy (be aware that due to the height is half the standard dustbin, the pressing time on the lid is also half of the standard bin); When there is not enough capacity for the rubbish, firstly watch out if the 2^{nd}-balancer is connected with the 1^{st}-balancer. If not, pressing the lid a few more times until they clamp together, then push the gliding bar to come off the large driving wheel (and the linkage sleeve also set the 2^{nd}-switch to the position to allow the 2^{nd}-balancer going downwards), and erect the lid in vertical position, and pull to extend the bin, its capacity will be doubled. When rubbish needs to be collected, press the 1^{st} switch, the dustbin will come up automatically. After the rubbish collection, repeat this process cycle.

The measurement of the top edge of the dustbin follows the standard wheelie bin, but is set as thin as possible in order to make the recess of the device top shallower for easy design of the 2^{nd} defense of waterproof. And the lid design, besides the functionality, tries to break through its traditional appearance; its hinge (43, FIG. 13) design considers waterproof and turning 270 requirement, as well as hand grabs (48) for the handling of the bin. Please refer to the Application Example 1 for more details.

### FIGURES ILLUSTRATION

Below is the outline of all the figures:

FIG. 1 Isometric Figure of the Device

FIG. 2 Plan View of the Design

FIG. 3 Section A-A

FIG. 4 Section B-B

FIG. 5 D-2^{nd} Balancer System Simplified Diagram (view from right to left)
A-C Diagrams Illustrating 2^{nd} Stepping Applying Gear and
2^{nd}-Switch Linkage Sleeve Operational Principle (view from left to right):
A (A1) Operating Mode (29 if the Runner of the Linkage Sleeve 28)
B—Separate Mode
C (C1) Operating Gliding Bar Resting on Opening Lip (top lid in 90)

FIG. 6 Operating Principle of 2^{nd}-Switch (E1 showing when toggle bar on left, ratchet wheel and its axle can turn clockwise, not allowing turn counter clockwise; E2 vice versa)

FIGS. 7 (1-4) 2^{nd}-Balancer and Clutch's Operating Principle and Working States

FIG. 8 Scissor Type Clutch Illustration

FIG. 9 Latch Type Clutch Illustration

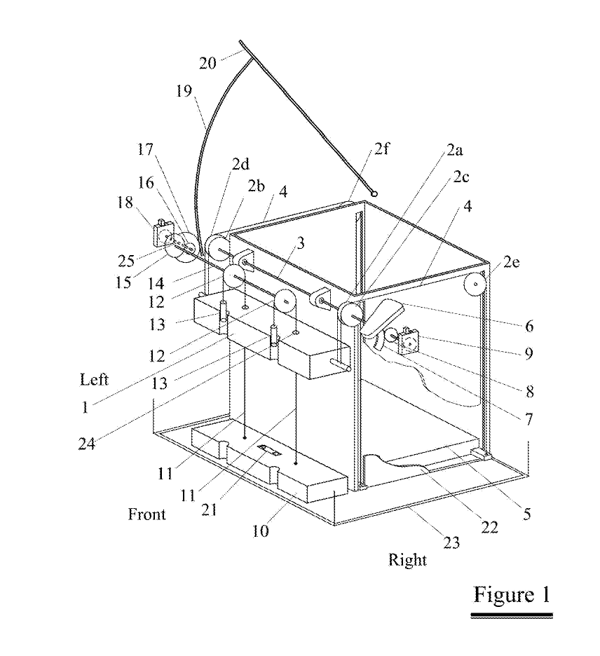

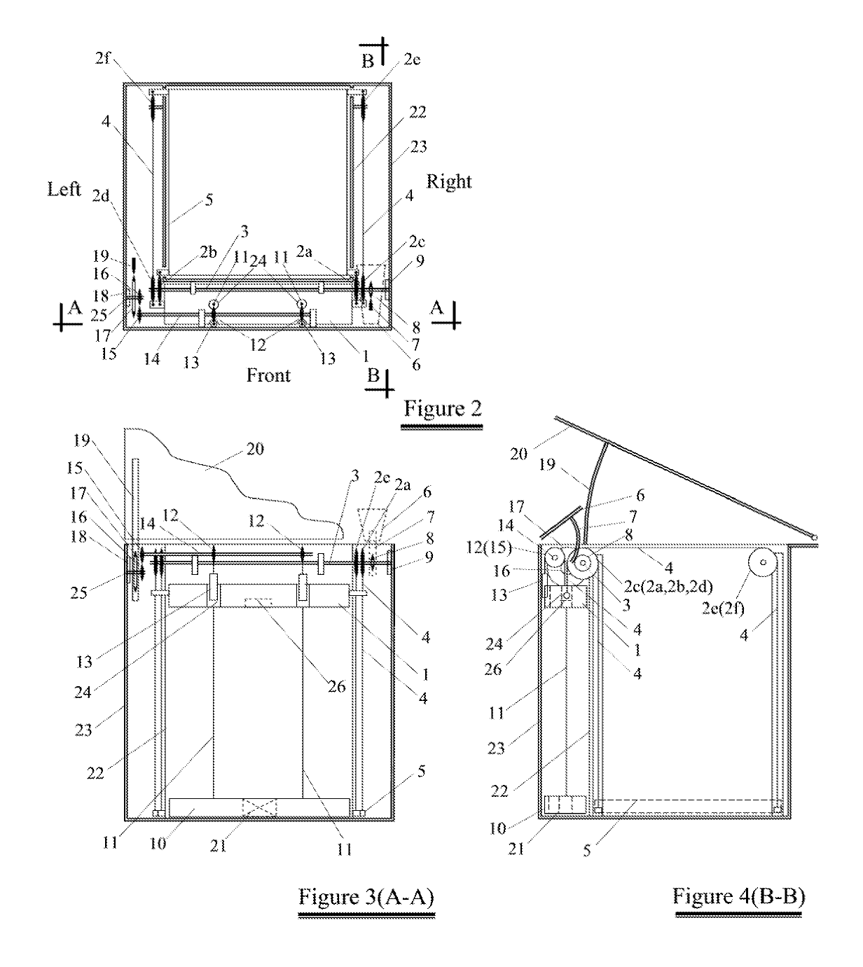

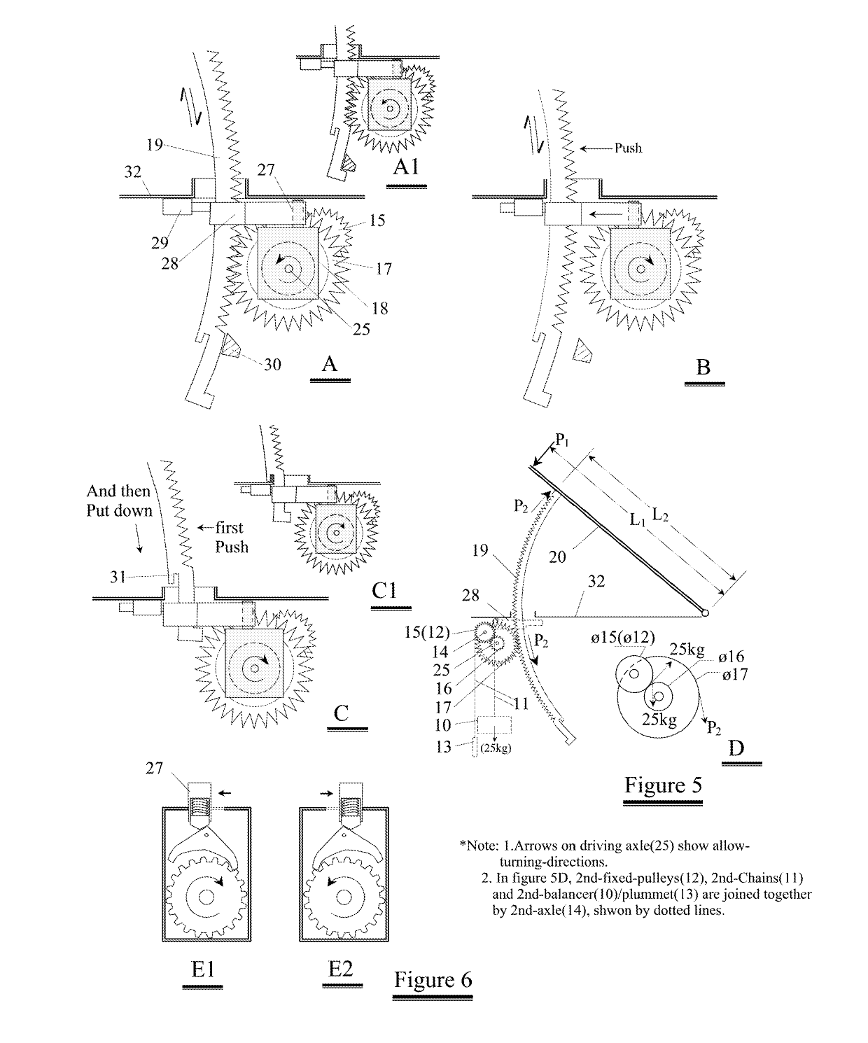

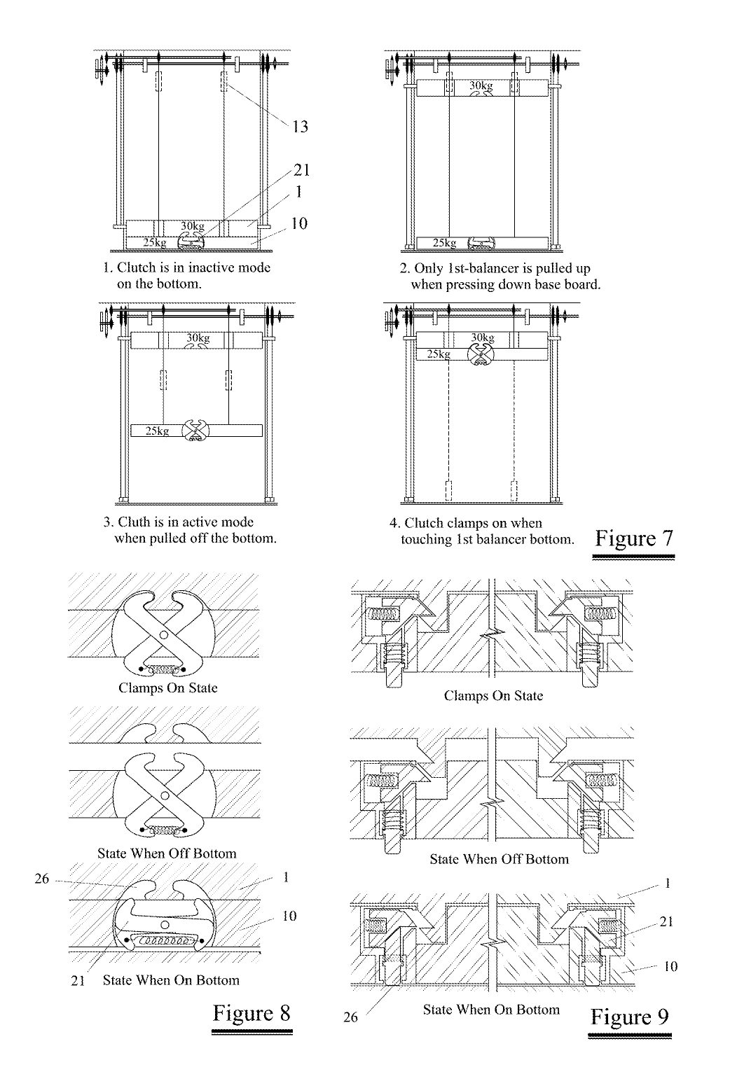

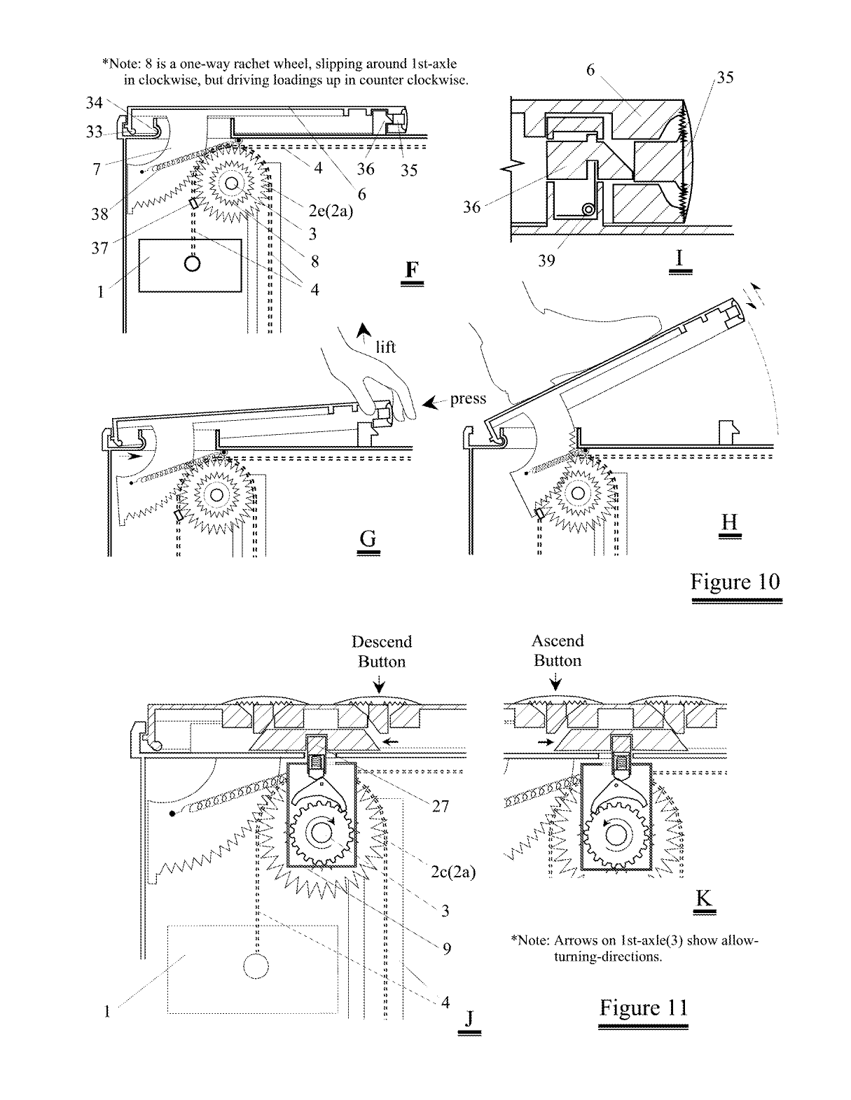

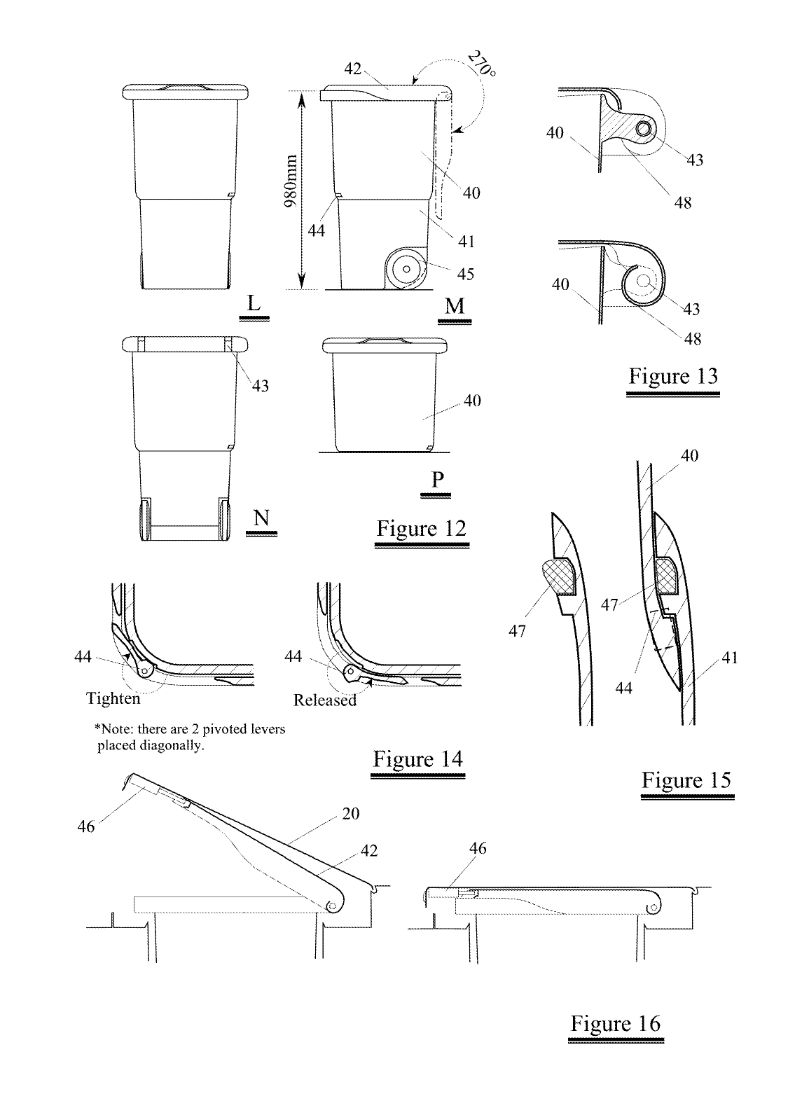

FIG. 10 1^{st} Applying Gear of Auxiliary Lifting—Pedal Design
F When Pedal is Level: fixing bolt (36) holds down the pedal, 1^{st}-gliding-bar (7) is separated with the fly wheel (8)
G Lifting the Pedal: Press separating button (35) to lift up pedal
H Working Mode: press pedal repeatedly to assist base board lifting
I Structure Illustration of Pedal Front Fixing Bolt: press button (35), fixing bolt (36) comes in, pedal can be lift up; 39 is a spring.

FIG. 11 Operating Principle of 1^{nd}-Switch and Its Matching Button Design:
J Press ‘Descend’, toggle bar (27) pushed to left, 1^{st}-axle can turn clockwise—base board can be pushed down.
K Press ‘Ascend’, toggle bar (27) is pushed to right, 1^{st}-axle can turn counter clockwise—base board can be lifted up.

FIG. 12 External Views of Retractable Wheelie Bin: L-Font; M-Side; N-Back;
P—Front When Retracted.

FIG. 13 Hinges and Hand Grips' Design of Retractable Wheelie Bin Lid

FIG. 14 Pivoted Lever Design of Retractable Wheelie Barrel

FIG. 15 Rubber Holding Ring Design for Upper and Lower Barrel of Retracting
Wheelie Bin

FIG. 16 Connecting Bolt Design of Device's Top Lid and Retractable Bin Lid

### APPLICATION

### Application Example 1

### Sinkable Dustbin Device

This example presents a device to hide away the standard wheelie bin or retractable wheelie bin described earlier, to transfigure city streets and increase useable space of households.

The lifting device uses the 3 systems mentioned above. The 1^{st}-balancer is a 30 kg cast iron block, which weighs up normal person's 20 kg+pressing force, plus 10 kg empty bin and base board's own weight, makes it easy to press into the ground. The 2^{nd}-balancer is a 25 kg cast iron block, making the total balancers' weight 55 kg, which satisfies the requirement of normal household weekly rubbish weight's lifting need. An Applying Gear of Auxiliary Lifting is for assisting lifting the rubbish load when occasionally rubbish weight exceeds total balancers' weight, so if rubbish loading is 60 kg (including base board and dust bin's own weight etc.), the difference between the load and the balancers is 60−55=5 kg, so applying 5 kg on to the pulling chains through the pedal can lift up the dustbin load.

All components and devices describe earlier are applicable here. More explanation of the design is as below:

As describe earlier, when taking back the empty dustbin from a collection, press ‘Descend’ button and press the empty dustbin into the ground; in the meantime, set the gliding bar connecting to the top lid (pull to the front) into working mode, and the clip on the connecting bolt (46) between the top lid and the dustbin lid. Then in everyday use, accumulate 2^{nd}-balancer's position energy by opening and closing the lid when throwing rubbish.

Be aware that when raising the dustbin, firstly the top lid has to be set in 90° position. However, if the 2^{nd} balancer is not in the highest position connected with the 1^{st}-balancer, press a few more times to make them connect before setting the gliding bar resting on the open lip. Failing to do so will trigger the linkage sleeve (28) pulling the toggle bar of the 2^{nd}-switch and the 2^{nd}-balancer will sink into the bottom of the device, therefore the 2^{nd}-balancer loses its effect in this process cycle.

When raising the dustbin to the ground level, disconnect the connecting bolt (46), set the top lid in 90° position and the gliding bar resting on the opening lip edge, then press ‘Ascend’ soft rubber button on the pedal, the 1^{st}-switch underneath will be pushed to allow the device to ascend. At this moment, if the total balancers' weight can pull up the load, the dustbin will gradually raise up to the ground level; otherwise, giving a little push via the pedal will lift it up, too.

The pedal's design also considers combined operations to simplify the application. When putting down the pedal, pull back and press down to lock into the fixing bolt under the pedal, the gliding bar under it will come off the fly wheel at the same time. So when the dustbin needs to be pushed into the ground, only need press the ‘Descend’ soft rubber button will set the 1^{st} switch to allow descending, no need to think about separating the 1^{st}-gliding-bar and the fly wheel (otherwise pressing down dustbin will flick up the pedal and obstructed by it, causing the dustbin cannot push down), and reduce the complication of the application. Placing the ‘Ascend’ and ‘Descend’ buttons on the pedal is a simplified design which is also an advantage for water proof.

This application not only can use standard wheelie bin, but also use the retractable wheelie bin described earlier. Please refer to the early description of the 2^{nd} Stepping Apply Gear of the 2^{nd} balancer system and the illustration in FIG. 5D, we are going to estimate its torque and operating effect by giving a few assumptions:

Use ø as diameter (component 15's diameter is ø15, etc.), assume ø15=ø12, then the peripheral linear forces of 15 and 12 are equal; assume ø17 and ø16 are 130 mm and 38 mm respectively, then the ratio of these 2 wheels is:

ø17/ø16=130 mm/38 mm=3.4/1

Set the arms of forces on 2^{nd}-press-lever (20) as 900 mm and 760 mm respectively, the ratio of them is:

L1/L2=900 mm/760 mm=1.184/1

The total ratio of the moment from the pressing point to the 2^{nd}-balancer is the accumulation of these two applied moments, which is:

3.4×1.184=4.0

In other words, P1 (pressing force) is ¼ of the 2^{nd} balancer, 25 kg×¼=6.25 kg

As mentioned earlier, moving distance ratio is the reverse ratio of the forces, the 2^{nd}-balancer raising height is ¼ of the press distance. Assuming each time lift up the top lid and press down 600 mm distance, then the 2^{nd}-balancer will be raised 600×¼=150 mm, 7 days operations would raise 7×150=1050 mm, it is about the height of a standard wheelie bin's lifting device. Actual opening times and height may vary, but device is matching our design which set weekly routine operation to accumulate 2^{nd}-balancer's energy, plus the 1^{st}-balancer weight, it can fulfil the requirement of lifting weekly rubbish weight. When using retractable wheelie bin, balancers and all other components remain the same, only the height of the lifting device is half of the standard one, thus the lifting height of the balancers is also half, that means the pressing times of lifting operation of 2^{nd}-balancer is half of the standard one, in other words, when extending the bin in the mid-week, there is most probably no need to press extra times before erecting the top lid (in 90° position; and cannot press the top lid afterwards) as 2 balancers are connected.

Using 3 systems together in this example is an ideal combination, which provides a solution for processing the maximum loading, so this combination can be used in commercial field like commercial dustbin, or other heavy applications such as garden rainwater collection device, compost container, etc. In specific usage of the application, the lifting device can adopt any 1 or 2 of these 3 systems to suit different using habit or different budget requirements, details as below (these are also general characteristic portraits of different systems and combinations):
1. The most simple and low cost, 1^{st} balancer system only. Using a 30 kg balancer with normal person's 20-30 kg press or lift force, a simple system like that can handle a normal weekly rubbish weight a normal household storage which is approximately 30 kg: if it is less than 30 kg, the dustbin can ascend by itself; if it is quite heavy, let say 50 kg, a normal person still can use only about 20 kg lifting force to lift up the bin after the balancer cancels out 30 kg weight. Therefore this is a cheap but viable solution.
2. A combination of 1^{st} and 2^{nd} balancer system. Because of the 55 kg total balancing weight, plus the 20-30 kg lifting force, this combination can handle 75-85 kg rubbish load. As a lot of local governments have a restriction on maximum dustbin weight, the chance of using the 1^{st} Apply Gear of Auxiliary Lifting is nil, so this combination is an ideal solution for a moderate budget.
3. 2^{nd} balancer system only (please note that all single or combined system without 1^{st} balancer system still needs to use its chain and pulley mechanism which pulls the base board, 1^{st}-switch, and those components which connect the 2 systems, such as the clutch device (the groove or lugs feature), etc. to connect with those system to make it work). This single system has a feature of no requirement of press down the dustbin as it can sink down into the ground by itself, then using the movement of opening and closing the top lid to accumulate energy for lifting the bin later. We can give a heavier 2^{nd}-balancer weight here, say 30-40 kg, we need to balance the pressure, pressing times etc. according to the total lifting height.
4. A combination of 2^{nd} balancer system and the 1^{st} applying gear of auxiliary lifting. This combination has the characteristics of the 3 solution, but is with a pedal as a backup for lifting heavier rubbish load.
5. 1^{st} Applying Gear of Auxiliary Lifting system only (also need to retain 1^{st}-axle, 1^{st}-chains and pulleys, and 1^{st}-switch for the system to apply its force). This is also a simple and low cost solution, with a feature of which the bin can sink in automatically. When needing to lift the rubbish load, just lift up the pedal a press up the underground bin. By using the lever principle, and a user can easily use their body weight to apply a few dozen kilograms or even their body weight, this system can be used as a heavy load lifting device. Its drawback is that its operation can be a bit slow.
6. A combination of 1^{st} balancer system and 1^{st} applying gear of auxiliary lifting system. This plan needs to press down the bin in order to store a certain amount of energy first, then when lifting loads, if the balancer weight is not enough, just lift up the pedal for assistance. Also, this is a plan for lifting quite heavy loads due to a user can easily use their body to apply foot force.

In all the solutions describe above, users can use extra lifting force to lift up dustbin load, so as long as its lifting force plus the balancer weight (when using the 1^{st} Applying Gear of Auxiliary Lifting system, the balancer weight is 0) greater than the load, the dustbin can be lifted up.

### Application Example 2

### Domestic Storage Cabinet

This example can be used as varied domestic sundries storage solutions. Because there is no regular opening/closing top lid movement, the 2^{nd} balancer system can be omitted, let use the cheapest low cost 1^{st} balancer system. Its balancer weight can be set with weight of potential item(s) storing, and considering operating pressing and lifting force, say 20 kg, therefore, the difference of the minimum and maximum nominal loadings is 40 kg. So, if storage for gardening or DIY tool is heavy, 80-120 kg nominal loads (including the container's weight) can be chosen, and 100 kg mid-value balancer weight can be set. Therefore, a user can easily press or lift 20 kg force to operate the storage device. As there is no need of pulling the cabinet away for this device, we combine the cabinet with the base board, set some shelves for sorting items; the top lid is also not needed and can be designed with the waterproof requirement. If it is for light objects, say, a sinkable receiving cabinet of internet grocery shopping, or a sinkable storage facilities for households with ground floor (such as a sinkable chest of drawers, etc.), 20 kg balancer is possibly enough, for this kind of application, this single 1^{st} balancer system like this would be very easily handled and flexible.

If use different combination of 1^{st} and (or) 2^{nd} balancer systems (a lever arm needed to be added for separate operation of lifting 2^{nd}-balancer) and (or) 1^{st} applying gear of auxiliary lifting system, its cost would be higher, but for heavy loading handling, it would save a lot of strength and increase the level of convenience.

Although the invention is revealed with a few applicable examples, it is not restricted with its extent of usage by them. A slight alteration upon this invention by anyone in the field will be forbidden as it would still fall into the claimed rights of it.

1. A lifting gear, which includes:
a 1^{st}-axle with a 1^{st}-direction-controlling ratchet wheel switch and a set of 1^{st}-fixed-pulleys, a set of 1^{st}-chains with a 1^{st}-balancer on one end and on the other end a base board, which moves in reverse direction with the 1^{st}-balancer.

2. A lifting gear according to claim 1, in which it also includes:
a 2^{nd}-axle with a pair of 2^{nd}-fixed-pulleys turning synchronously;
2^{nd}-balancer hanged under the 1^{st}-balancer by a pair of 2^{nd}-chains through holes on the 1^{st}-balancer. In the 2^{nd}-balancer, there is a clutch which can cling onto or release from the 1^{st}-balancer when it touches the bottom of the 1^{st}-balancer, depending on its position in the operation. A 2^{nd}-stepping gear for pulling up the 2^{nd}-balancer, which goes up a certain distance each time, consists of a driven wheel attached to the 2^{nd}-axle, a small driving wheel, a large driving wheel, a 2^{nd}-gliding-bar, a pressure lever and a 2^{nd} direction-controlling ratchet wheel on the axle of the driving wheels.

3. A lifting gear according to claim 2, in which the pair of 1^{st}-fixed-pulleys consists of a pair of toothed wheels and another set of 4 toothed or rope wheels working synchronically, in order to keep the base board level. The pair of 2^{nd}-fixed-pulleys can also be toothed or rope wheels.

4. A lifting gear according to claim 2, in which the clutch in the 2^{nd}-balancer is in inactive mode when it is on the bottom of the device, but is in active mode when it is off the bottom. When the 2^{nd}-balancer ascends until it touches the bottom of the 1^{st-}balancer, the clutch clamps and clings on to the 1^{st-}balancer; there is a groove or a lug on the bottom of the 1^{st} balancer which is for the clutch to clamp on; the clamping device is a spring device.

5. A lifting gear according to claim 1, in which there is a 1^{st} apply gear for assisting in hoisting the base board, it consists of a pressing surface, a 1^{st}-gliding-bar underneath and a fly wheel, which is a one-way turning ratchet fixed on the 1^{st-}axle.

6. A lifting gear according to claim 1, in which there is also a housing, which consists of an outer and an inner case.

7. A container used within the device described in claim 1-6.

8. A container according to claim 7, in which the container is a wheelie bin.

9. A container according to claim 8, in which the wheelie bin is a standard wheelie bin for standard garbage trucks.

10. A container according to claim 8, in which the dustbin is a retractable wheelie bin, with a standard wheelie bin height when it is stretched and half height when retracted.
